(19) United States
(12) Patent Application Publication
(10) Pub. No.: US 2011/0084055 A1
(43) Pub. Date: Apr. 14, 2011

(54) STEERING WHEEL-HEATING SYSTEM AND METHOD OF HEATING STEERING WHEEL

(75) Inventors: Sekil PARK, Suwon-si (KR); Hyunwoo Lim, Hwaseong-si (KR)

(73) Assignee: HYUNDAI MOTOR COMPANY, Seoul (KR)

(21) Appl. No.: 12/876,803

(22) Filed: Sep. 7, 2010

(30) Foreign Application Priority Data
Oct. 8, 2009 (KR) 10-2009-0095520

(51) Int. Cl. B60L 1/04

(52) U.S. Cl. 219/204

(57) ABSTRACT

A steering wheel-heating system may include an ambient sensor detecting temperature of external air, an incar sensor detecting temperature of internal air of a vehicle, a water temperature sensor detecting temperature of engine cooling water, a temperature switch receiving FATC-set (Full Auto Temperature Control) temperature, and a controller supplying or cutting power supplied to heating wires in a steering wheel on the basis of the temperature of the external air detected by the ambient sensor, the temperature of the internal air detected by the incar sensor, the temperature of the engine cooling water detected by the water temperature sensor, and the FATC-set temperature.

### CROSS-REFERENCE TO RELATED APPLICATIONS

The present application claims priority to Korean Patent Application Number 10-2009-0095520 filed Oct. 8, 2009, the entire contents of which application is incorporated herein for all purposes by this reference.

### BACKGROUND OF THE INVENTION

1. Field of the Invention

The present invention relates to a steering wheel-heating system, in more detail a steering wheel-heating system automatically controlling heating wires in a steering wheel by monitoring temperature of external air, cooling water, and the interior etc.

2. Description of Related Art

Vehicles are soaked by the cold external air for a long time and the steering wheels are also kept cold by the cold external air in winter, especially hard winter. Drivers holding and operating the steering wheels to start driving the vehicles feel unpleasant and have a difficulty in operating the steering wheel, because it is cold.

Addressing the problems, vehicles manufactured in recent years are equipped with a steering wheel-heating system to control the surface temperature of the steering wheel. The steering wheel-heating system is a system having built-in heating wires and heating the surface of the steering wheel for a predetermined time, using the heating wire, which generates heat by the operation of the driver.

FIG. 1 is a block diagram illustrating a steering wheel-heating system in the related art.

The steering wheel-heating system includes: heating wires 11 disposed in the steering wheel; a heating wire switch 12 attached to the steering column and turned on/off by the driver; a battery supplying power to the system; a timer 14 automatically turned off after operating for a predetermined time (e.g. 30 minutes) when heating wire switch 12 is turned on; and a controller 15 supplies power of a battery to heating wire 11 to heat the steering wheel while timer 14 operates.

According to the steering wheel-heating system, timer 14 operates for a predetermined time (30 minutes) when the driver turns on heating wire switch 12, and is then automatically turned off. Controller 15 supplies power of the battery to heating wire 11 to heat it, with timer 14 turned on. The steering wheel-heating system has a problem that it heats the steering wheel only for 30 minutes when the driver operates one time heating wire switch 12, and the driver has to turn on again heating wire switch 12 to restart the system.

That is, according to the steering wheel-heating system, since the heating wires do not start operating before the driver turns on heating wire switch 12, the driver has to manually turn on the heating wire switch to start the system and turn on again the heating wire switch to restart the system after a predetermined time has passed.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a steering wheel-heating system automatically controlling heating wires in the steering wheel in combination with an FATC (Full Auto Temperature Control) system of the vehicle, and a method of hearing the steering wheel.

In an aspect of the present invention, the steering wheel-heating system may include an ambient sensor detecting temperature of external air, an incar sensor detecting temperature of internal air of a vehicle, a water temperature sensor detecting temperature of engine cooling water, a temperature switch receiving FATC-set (Full Auto Temperature Control) temperature, and a controller supplying or cutting power supplied to heating wires in a steering wheel on the basis of the temperature of the external air detected by the ambient sensor, the temperature of the internal air detected by the incar sensor, the temperature of the engine cooling water detected by the water temperature sensor, and the FATC-set temperature.

The steering wheel-heating system may include a heating wire temperature sensor detecting temperature of the heating wires in the steering wheel and sending data of the detected temperature to the controller, wherein the controller cuts the power supplied to the heating wires, when the temperature of the heating wires becomes larger than upper critical heating wire temperature.

The controller may supply the power to the heating wires, when the temperature of the heating wires becomes lower than low critical heating wire temperature.

The steering wheel-heating system may further include a manual heating wire switch that is turned on manually by a driver, and a timer that operates for a predetermined time, when the manual heating wire switch is turned on, wherein the controller supplies power to the heating wires, when the timer is in operation.

The controller may supply power to the heating wires in the steering wheel, when the temperature of the external air is lower than critical external air temperature, and the temperature of the internal air is lower than critical internal air temperature or the temperature of the cooling water is lower than lower critical cooing water temperature, and after the controller supplies power to the heating wires in the steering wheel, the controller may cut the power supplied to the heating wires in the steering wheel, when the temperature of the cooling water is higher than upper critical cooling water and the difference between the temperature of the internal air and the FATC-set temperature is less than a critical value.

In another aspect of the present invention, a method of heating a steering wheel in combination with a FATC (Full Auto Temperature Control) system, may include a first step of comparing temperature of external air with critical external air temperature by a controller, a second step of comparing temperature of internal air with critical internal air temperature and temperature of cooling water with lower critical cooling water temperature, when the temperature of the external air is not higher than the critical external air temperature as a result of the first step, a third step of supplying power to heating wires in the steering wheel, when the temperature of the internal air is not higher than the critical internal air temperature and the temperature of the cooling water is not higher than the lower critical cooling water temperature as a result of the second step, and a fourth step of cutting power supplied to the heating wires in the steering wheel, when the temperature of the cooling water is higher than upper critical cooling water temperature and the difference between the temperature of the internal air and FATC-set temperature is less than a critic value, after the third step.

The heating method of heating a steering wheel may further include a fifth step of cutting the power supplied to the heating wires in the steering wheel, when temperature of the heating wires in the steering wheel is higher than upper critical heating wire temperature, after the third step.

The heating method may further include supplying the power to the heating wires, when the temperature of the heating wires becomes lower than low critical heating wire temperature.

After the third step, the power may be continuously supplied to the heating wires in the steering wheel while the temperature of the cooling water is less than or equal to the upper critical cooling water temperature and the difference between the temperature of the internal air and the FATC-set temperature is equal to or higher than the critic value.

According to the present invention, it is possible to provide comfortable circumstances for drivers by controlling heating wires in a steering wheel on the basis of various sensed values of an FATC system of a vehicle to maintain optimal temperature of the steering wheel. Further, it is possible to improve convenience of drivers, because they do not need to operate a heating wire switch.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a block diagram illustrating a steering wheel-heating system in the related art.

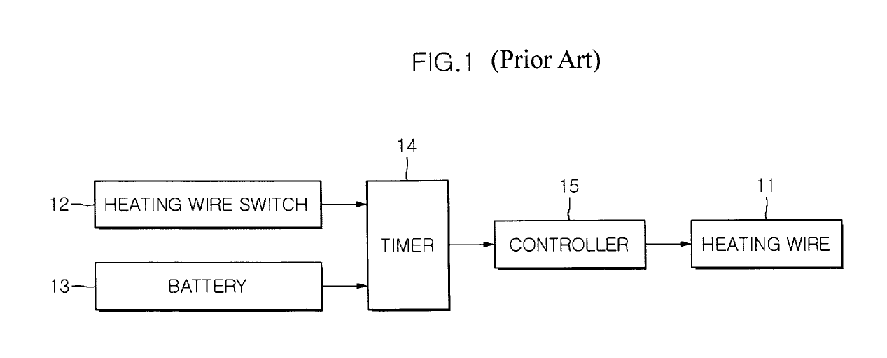

FIG. 2 is a views showing heating wires disposed in a steering wheel.

FIG. 3 is a block diagram illustrating the function of a steering wheel-heating system according to an embodiment of the present invention.

FIG. 4 is a flows chart illustrating a method of heating a steering wheel according to an embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Exemplary embodiments of the present invention are described hereafter in detail with reference to the accompanying drawings.

An FATC system is a system maintaining comfortable circumstance in a vehicle irrespective of external conditions by automatically controlling the direction and amount of ventilation and conditions of the internal and external air. The FATC system maintains the temperature inside the vehicle at FATC-set temperature inputted by the driver, by controlling a variety of module motors (a mode door motor, an air mixed door motor, and an internal/external door motor) through logic calculation in an FATC controller, in response to input signals of various sensors (for temperature of internal air and external air, cooling water, and amount of insolation) and a control switch.

The FATC system is equipped with a variety of sensors, including an incar sensor detecting the temperature of the internal air of a vehicle, an ambient sensor detecting the temperature of the external air, and a water temperature sensor detecting the temperature of the engine-cooling water.

The steering wheel-heating system according to an embodiment of the present invention automatically controls heating wires in the steering wheel, using the results sensed by the sensors of the FATC system.

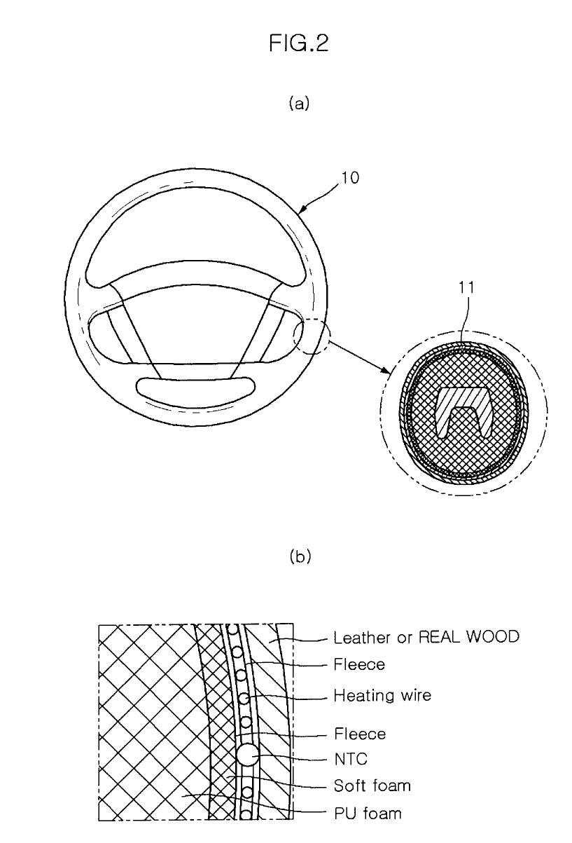

FIG. 2 is a view showing heating wires in a steering wheel, in which circular heating wires 11 are disposed around a steering wheel 10. The (b) of FIG. 2 is a cross-sectional view showing the inside of the steering wheel, in which the outermost surface of the steering wheel is made of leather or real wood, the heating wires and heating wire temperature sensor are disposed inside the outermost surface, and fleece is filled in between them.

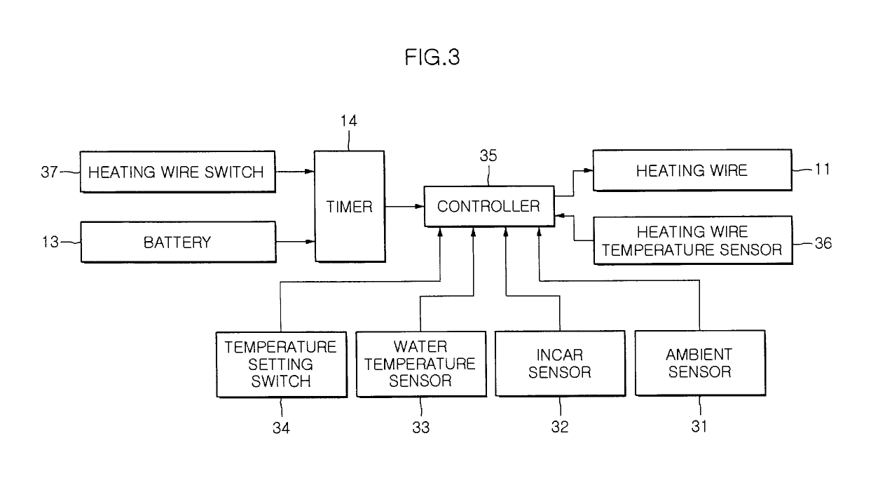

FIG. 3 is a block diagram illustrating a steering wheel-heating system according to an embodiment of the present invention.

A steering wheel-heating system according to an embodiment of the present invention includes, an ambient sensor 31 detecting the temperature of the external air, an incar sensor 32 detecting the temperature the internal air of a vehicle, a water temperature sensor 33 detecting the temperature of the engine-cooling water, a temperature switch 34 receiving set-temperature of the FATC, and a controller 35 supplying/cutting the power for heating wires 11 in the steering wheel on the basis of the temperature of the external air detected by ambient sensor 31, the temperature of the internal air detected by incar sensor 32, and the temperature of the engine-cooling water detected by water temperature sensor 33.

Further, the steering wheel-heating system further includes a heating wire temperature sensor 36 that detects and supplies the temperature of the heating wires in the steering wheel to controller 35 and a manual heating wire switch 37 that is manually operated by the driver.

As the driver turns on manual heating wire switch 37, a timer 14 is activated for a predetermined time, and controller 35 supplies power to heating wires 11 to heat the surface of the steering wheel while timer 14 is in operation, which is the same as the related art.

Controller 35 supplies power to heating wires 11 with the start of the engine, when the temperature of the external air is lower than a critical external air temperature, the temperature of the engine-cooling water is lower than a low critical cooling water temperature, and the temperature of the internal air is lower than a critical internal air temperature. Thereafter, it cuts the power supplied to heating wires 11, when a difference between the temperature of the internal air and the FATC-set temperature comes close to a critical value. Further, controller 35 supplies power again to heating wire 11, when the temperature of the internal air becomes lower than the critical internal air temperature and the temperature of the cooling water becomes lower than the critical cooling water temperature.

Furthermore, controller 35 cuts again the power supplied to heating wire 11, when the temperature of the heating wires detected by heating wire temperature sensor 36 is higher than an upper critical heating wire temperature. Thereafter, it supplies power to heating wires 11, when the temperature of the heating wire becomes lower than the low critical heating wire temperature.

Ambient sensor 31, incar sensor 32, water temperature sensor 33, and temperature switch 34 may be separately mounted and used in combination with corresponding components in the FATC system.

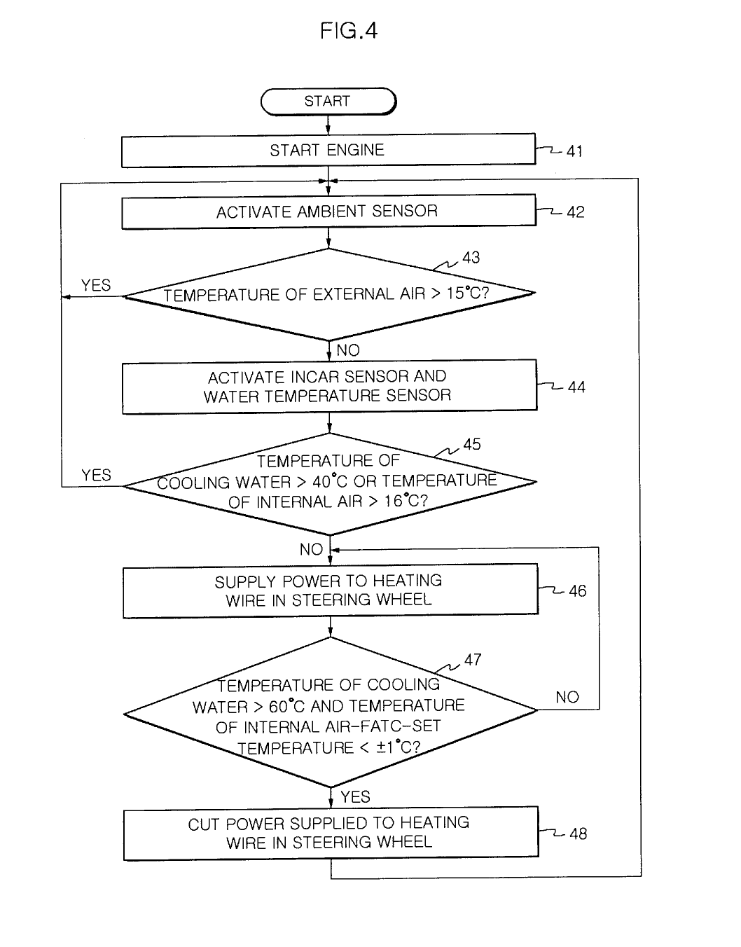

FIG. 4 is a flows chart illustrating a method of heating a steering wheel according to an embodiment of the present invention.

First, as the engine starts (S41), controller 35 controls ambient sensor 31 to start detecting (S42).

This process returns to step S42, when the temperature of the external air detected by ambient sensor 31 is higher than the critical external air temperature (e.g. 15° C.)(S43). On the other hand, incar sensor 32 and water temperature sensor 33 start detecting (S44), when the temperature of the external air detected by ambient sensor 31 is not higher than the critical external air temperature (15° C.) (S43).

The process returns to step S42, when the temperature of the cooling water detected by water temperature sensor 33 is higher than the low critical cooling water temperature (e.g. 40° C.) or the temperature of the internal air detected by incar sensor 32 is higher than the critical internal air temperature (e.g. 16° C.) (S45). On the other hand, power is supplied to the heating wires in the steering wheel, when the temperature of the cooling water is not higher than the low critical cooling water temperature and the temperature of the internal air is not higher than the critical internal air temperature in step S45 (S46).

The power supplied to the heating wires in the steering wheel is cut, when the temperature of the cooling water detected by water temperature sensor 33 is above the upper critical cooling water temperature (e.g. 60° C.) and the difference between the temperature of the internal air detected by incar sensor 32 and the FATC-set temperature is within the critical value (e.g. ±1° C.) (S47), after step S46 (S48). The process returns to step S42 after step S48.

On the other hand, the power continues being supplied to the heating wires in the steering wheel in step S46, when the temperature of the cooling water is not above the upper critical cooling water temperature or the difference between the temperature of the internal air and the FATC-set temperature are not within the critical value after step S46 (S47).

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A steering wheel-heating system comprising:
an ambient sensor detecting temperature of external air;
an incar sensor detecting temperature of internal air of a vehicle;
a water temperature sensor detecting temperature of engine cooling water;
a temperature switch receiving FATC-set (Full Auto Temperature Control) temperature; and
a controller supplying or cutting power supplied to heating wires in a steering wheel on the basis of the temperature of the external air detected by the ambient sensor, the temperature of the internal air detected by the incar sensor, the temperature of the engine cooling water detected by the water temperature sensor, and the FATC-set temperature.

2. The steering wheel-heating system as defined in claim 1, further comprising:
a heating wire temperature sensor detecting temperature of the heating wires in the steering wheel and sending data of the detected temperature to the controller,
wherein the controller cuts the power supplied to the heating wires, when the temperature of the heating wires becomes larger than upper critical heating wire temperature.

3. The steering wheel-heating system as defined in claim 2, wherein the controller supplies the power to the heating wires, when the temperature of the heating wires becomes lower than low critical heating wire temperature.

4. The steering wheel-heating system as defined in claim 1, further comprising:
a manual heating wire switch that is turned on manually by a driver; and
a timer that operates for a predetermined time, when the manual heating wire switch is turned on,
wherein the controller supplies power to the heating wires, when the timer is in operation.

5. The steering wheel-heating system as defined in claim 1,
wherein the controller supplies power to the heating wires in the steering wheel, when the temperature of the external air is lower than critical external air temperature, and the temperature of the internal air is lower than critical internal air temperature or the temperature of the cooling water is lower than lower critical cooing water temperature, and
wherein after the controller supplies power to the heating wires in the steering wheel, the controller cuts the power supplied to the heating wires in the steering wheel, when the temperature of the cooling water is higher than upper critical cooling water and the difference between the temperature of the internal air and the FATC-set temperature is less than a critical value.

6. A method of heating a steering wheel in combination with a FATC (Full Auto Temperature Control) system, the method comprising:
a first step of comparing temperature of external air with critical external air temperature by a controller;
a second step of comparing temperature of internal air with critical internal air temperature and temperature of cooling water with lower critical cooling water temperature, when the temperature of the external air is not higher than the critical external air temperature as a result of the first step;
a third step of supplying power to heating wires in the steering wheel, when the temperature of the internal air is not higher than the critical internal air temperature and the temperature of the cooling water is not higher than the lower critical cooling water temperature as a result of the second step; and
a fourth step of cutting power supplied to the heating wires in the steering wheel, when the temperature of the cooling water is higher than upper critical cooling water temperature and the difference between the temperature of the internal air and FATC-set temperature is less than a critic value, after the third step.

7. The heating method of heating the steering wheel as defined in claim 5, further comprising a fifth step of cutting the power supplied to the heating wires in the steering wheel, when temperature of the heating wires in the steering wheel is higher than upper critical heating wire temperature, after the third step.

8. The heating method of heating the steering wheel as defined in claim 7, further comprising supplying the power to the heating wires, when the temperature of the heating wires becomes lower than low critical heating wire temperature.

9. The heating method of heating the steering wheel as defined in claim 6, wherein after the third step, the power is continuously supplied to the heating wires in the steering wheel while the temperature of the cooling water is less than or equal to the upper critical cooling water temperature and the difference between the temperature of the internal air and the FATC-set temperature is equal to or higher than the critic value.
